(19) United States
(12) Patent Application Publication
(10) Pub. No.: US 2018/0149530 A1
(43) Pub. Date: May 31, 2018

(54) FORCE SENSOR AND ROBOT

(71) Applicant: Seiko Epson Corporation, Tokyo (JP)

(72) Inventor: Mitsuhiro YAMAMURA, Suwa (JP)

(21) Appl. No.: 15/822,502

(22) Filed: Nov. 27, 2017

(30) Foreign Application Priority Data
Nov. 29, 2016 (JP) 2016-231824

(51) Int. Cl. G01L 1/16; G01L 5/00

(52) U.S. Cl. CPC G01L 1/16; B25J 13/085; Y10S 901/46; G01L 5/0028

(57) ABSTRACT

A force sensor includes a plurality of piezoelectric elements that output charge when subjected to an external force, each of the plurality of piezoelectric elements has two electrodes and a piezoelectric material provided between the two electrodes, and the piezoelectric elements are arranged without overlap with each other in a plan view as seen from a direction in which the two electrodes are arranged, and the piezoelectric elements are electrically series-connected. The piezoelectric materials of the plurality of piezoelectric elements are integrally formed.

### BACKGROUND

### 1. Technical Field

The present invention relates to a force sensor and robot.

### 2. Related Art

A force sensor that detects a force is, for example, in a robot having a robot arm including at least one arm, provided in a joint part of the robot armor the like and detects a force applied to the robot arm.

As an example of the force sensor, a tactile sensor described in Patent Document 1 (JP-A-2002-031574) includes a piezoelectric element and detects a force based on output from the piezoelectric element.

However, in the tactile sensor described in Patent Document 1, if the output from the piezoelectric element is increased, noise is also increased and a problem with difficulty in increasing the S/N ratio arises.

### SUMMARY

An advantage of some aspects of the invention is to provide a force sensor in which the S/N ratio can be improved and a robot having the force sensor.

The advantage can be achieved by the following examples.

A force sensor according to an aspect of the invention includes a plurality of piezoelectric elements that output charge when subjected to an external force, each of the plurality of piezoelectric elements has two electrodes and a piezoelectric material provided between the two electrodes, and the piezoelectric elements are arranged without overlap with each other in a plan view as seen from a direction in which the two electrodes are arranged, the piezoelectric elements are electrically series-connected.

According to the force sensor having the above described configuration, the plurality of piezoelectric elements arranged without overlap with each other in the plan view are electrically series-connected, and thereby, compared to the case using one piezoelectric element having the same placement area (same plan view area), noise can be reduced and, as a result, the S/N ratio can be improved.

In the force sensor according to the aspect of the invention, it is preferable that the piezoelectric materials of the plurality of piezoelectric elements are integrally formed.

With this configuration, the processing of the piezoelectric materials is easier and, as a result, the manufacture of the plurality of piezoelectric elements is easier.

In the force sensor according to the aspect of the invention, it is preferable that the plurality of piezoelectric elements stacked in the direction in which the two electrodes are arranged are provided.

With this configuration, the sensitivity and the detection axes of the force sensor can be increased.

In the force sensor according to the aspect of the invention, it is preferable that the piezoelectric material is formed by quartz crystal.

With this configuration, the force sensor having excellent properties including higher sensitivity, wider dynamic range, higher rigidity can be realized.

In the force sensor according to the aspect of the invention, it is preferable that a charge amplifier to which the change is input is provided.

With this configuration, the charge (charge signals) output from the plurality of piezoelectric elements can be converted into voltages (voltage signals). Then, the external force applied to the plurality of piezoelectric elements can be easily and accurately calculated based on the voltage signals from the charge amplifier.

A force sensor according to an aspect of the invention includes a base portion having a placement surface, and a plurality of piezoelectric elements arranged side by side in a direction along the placement surface, electrically series-connected, and outputting charge when subjected to an external force.

According to the force sensor having the above described configuration, the plurality of piezoelectric elements arranged side by side along the placement surface are electrically series-connected, and thereby, compared to the case using one piezoelectric element having the same placement area (same plan view area), noise can be reduced and, as a result, the S/N ratio can be improved.

A robot according to an aspect of the invention includes the force sensor according to the aspect of the invention.

According to the robot having the above described configuration, the S/N ratio of the force sensor can be improved, and high-accuracy operation control of the robot can be realized using the detection result of the force sensor, for example.

### BRIEF DESCRIPTION OF THE DRAWINGS

The invention will be described with reference to the accompanying drawings, wherein like numbers reference like elements.

FIG. 1 is a plan view showing a force sensor according to a first embodiment of the invention.

FIG. 2 is a sectional view along line A-A in FIG. 1.

FIG. 3 is a sectional view of a force detection element (piezoelectric elements) of the force sensor shown in FIGS. 1 and 2.

FIG. 4 is a plan view of the force detection element (piezoelectric elements) of the force sensor shown in FIGS. 1 and 2.

FIG. 5 is a circuit diagram of the force sensor shown in FIGS. 1 and 2.

FIG. 6 is a sectional view of a force detection element (piezoelectric elements) of a force sensor according to a second embodiment of the invention.

FIG. 7 is a sectional view of a piezoelectric element of a force sensor according to a third embodiment of the invention.

FIG. 8 is a sectional view of a piezoelectric element of a force sensor according to a fourth embodiment of the invention.

FIG. 9 is a perspective view showing an example of a robot according to the invention.

### DESCRIPTION OF EXEMPLARY EMBODIMENTS

As below, a force sensor and robot according to the invention will be explained in detail based on embodiments shown in the accompanying drawings.

### First Embodiment

### Force Sensor

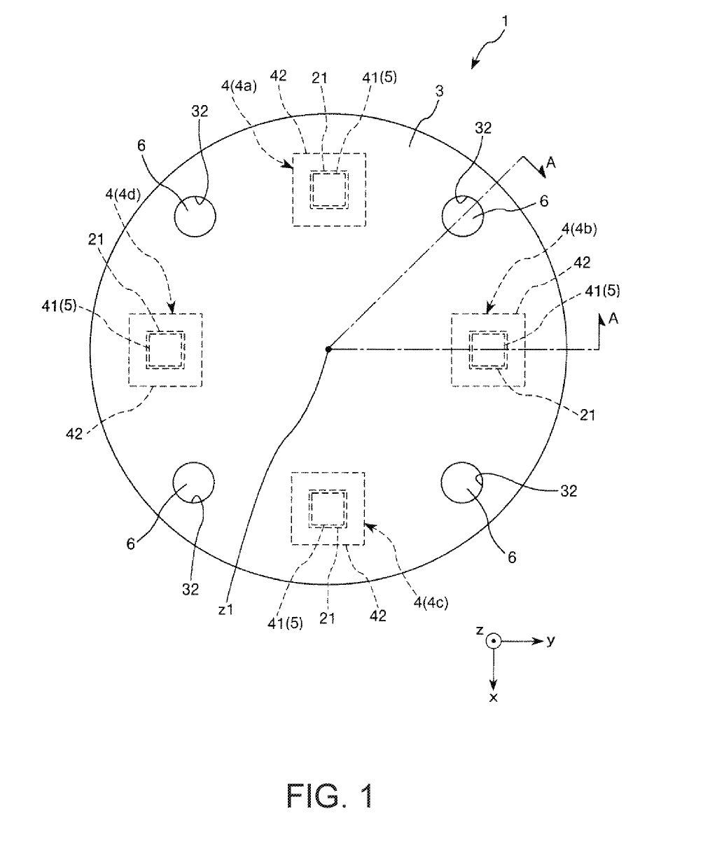

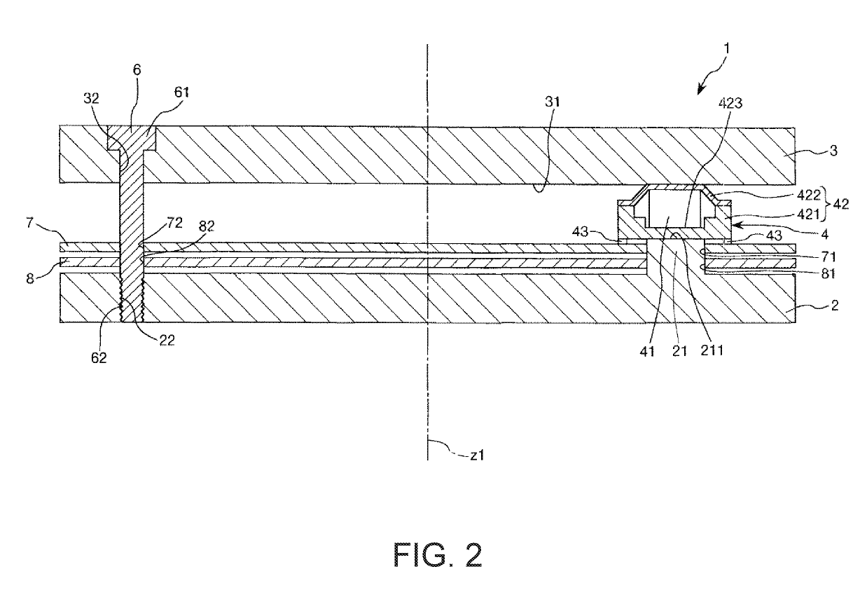

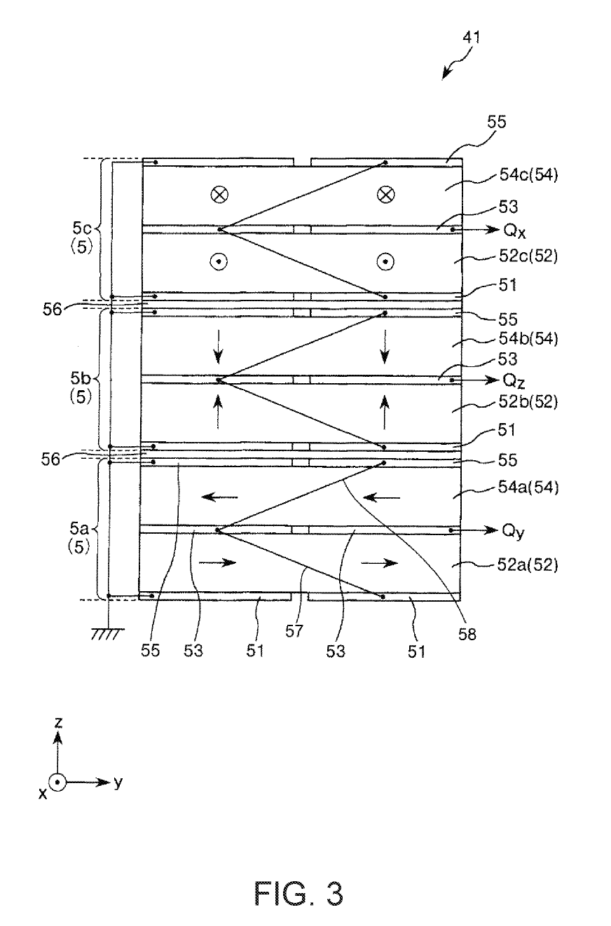

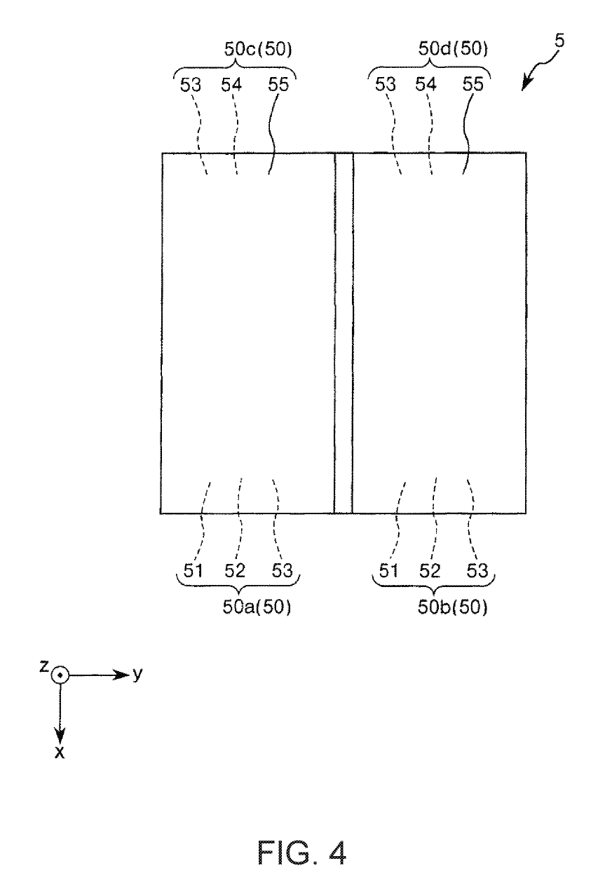

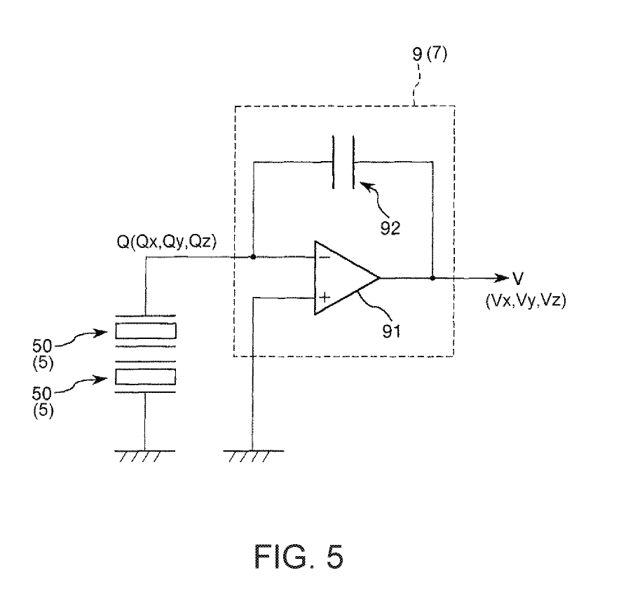

FIG. 1 is a plan view showing a force sensor according to the first embodiment of the invention. FIG. 2 is a sectional view along line A-A in FIG. 1. FIG. 3 is a sectional view of a force detection element (piezoelectric elements) of the force sensor shown in FIGS. 1 and 2. FIG. 4 is a plan view of the force detection element (piezoelectric elements) of the force sensor shown in FIGS. 1 and 2. FIG. 5 is a circuit diagram of the force sensor shown in FIGS. 1 and 2. Note that, in FIGS. 1, 3, and 4, respectively, for convenience of explanation, an x-axis, y-axis, and z-axis are shown as three axes orthogonal to one another and the tip end sides of arrows showing the respective axes are “+” and the base end sides are “−”. Further, directions parallel to the x-axis are referred to as “x-axis directions”, directions parallel to the y-axis are referred to as “y-axis directions”, and directions parallel to the z-axis are referred to as “z-axis directions”. Furthermore, the side in the +z-axis direction is also referred to as “upside” and the side in the −z-axis direction is also referred to as “downside”. A view as seen from the z-axis direction is referred to as “plan view”.

A force sensor 1 shown in FIG. 1 is a six-axis force sensor that can detect six-axis components of an external force applied to the force sensor 1. Here, the six-axis components include translational force (shear force) components in the respective directions of the three axes orthogonal to one another (in the drawings, the x-axis, y-axis, and z-axis) and rotational force (moment) components about the respective three axes.

As shown in FIG. 2, the force sensor 1 includes a first base part 2, a second base part 3 provided apart from the first base part 2, a plurality of (in the embodiment, four) sensor devices 4 provided between the first base part 2 and the second base part 3, an analog circuit board 7 and a digital circuit board 8, and a plurality of (in the embodiment, four) pressurization bolts 6 that fasten the first base part 2 and the second base part 3 to each other.

In the force sensor 1, signals according to external forces applied to the respective sensor devices 4 are output, the signals are processed by the analog circuit board 7 and the digital circuit board 8, and thereby, six-axis components of an external force applied to the force sensor 1 are detected.

### First Base Part

As shown in FIG. 2, the first base part 2 has an overall shape nearly in a plate shape. The outer shape of the first base part 2 in the plan view is a circular shape in the drawing, however, not limited to that. The shape may be e.g. a polygonal shape such as a rectangular shape or pentagonal shape, an oval shape, or the like. Further, on one surface (on the upside in FIG. 2) of the first base part 2, more specifically, on the surface on the second base part 3 side of the first base part 2, a plurality of convex portions 21 are provided in positions apart from an axis line z1. As shown in FIG. 1, the plurality of convex portions 21 are arranged at equal intervals to each other along the same circumference around the axis line z1. Further, as shown in FIG. 2, top surfaces 211 (end surfaces) of the respective convex portions 21 are flat surfaces. The shape of the top surface 211 is a square shape in the drawing, however, not limited to that. The shape may be e.g. a polygonal shape such as a rectangular shape or pentagonal shape, an oval shape, or the like. Further, a plurality of female screws 22 screwed together with the pressurization bolts 6 are provided in positions apart from the axis line z1. The plurality of female screws 22 are arranged at equal intervals to each other along the same circumference around the axis line z1.

The constituent material of the first base part 2 is not particularly limited to, but includes e.g. a metal material such as stainless, ceramics, etc. Note that, in the drawings, the convex portions 21 are integrally formed with the plate-shaped portion of the first base part 2, however, may be formed by other members than the plate-shaped portion. In this case, the constituent materials of the convex portions 21 and the plate-shaped portion may be the same or different.

### Second Base Part

As shown in FIG. 2, the second base part 3 has an overall shape nearly in a plate shape. The outer shape of the second base part 3 in the plan view is a circular shape in the drawing, however, not limited to that. The shape may be e.g. a polygonal shape such as a rectangular shape or pentagonal shape, an oval shape, or the like. Further, a plurality of through holes 32 through which the pressurization bolts 6 are inserted are provided in positions apart from the axis line z1 in correspondence with the plurality of female screws 22 of the above described first base part 2. In the upper portions of the respective through holes 32, step portions (wider-diameter portions) engaging with head portions 61 of the pressurization bolts 6 are formed.

The constituent material of the second base part 3 is not particularly limited to, but includes e.g. a metal material such as stainless, ceramics, etc. Note that, the constituent material of the second base part 3 may be the same as or different from the constituent material of the first base part 2.

### Sensor Devices

As shown in FIG. 2, each sensor device 4 has a force detection element 41 and a package 42 housing the force detection element 41.

The package 42 includes a base portion 421 having a concave portion with a placement surface 423 on which the force detection element 41 is placed as a bottom surface and a lid member 422 joined to the base portion 421, and the concave portion of the base portion 421 is sealed by the lid member 422. Thereby, the force detection element 41 may be protected. Here, the base portion 421 is placed on the top surface 211 of the convex portion 21 of the above described first base part 2. Further, a plurality of terminals 43 electrically connected to the analog circuit board 7 are provided on the lower surface of the base portion 421. The plurality of terminals 43 are electrically connected to the force detection element 41 via through electrodes (not shown) penetrating the base portion 421. The lid member 422 has a plate shape, and the surface on the base portion 421 side is in contact with the force detection element 41 and the opposite surface to the base portion 421 is in contact with the second base part 3.

The constituent material of the base portion 421 of the package 42 is not particularly limited, but e.g. an insulating material such as ceramics or the like may be used. The constituent material of the lid member 422 is not particularly limited, but e.g. various metal materials including stainless steel or the like may be used. Note that the constituent material of the base portion 421 and the constituent material of the lid member 422 may be the same or different. The shape of the package 42 in the plan view is a square shape in the drawing, however, not limited to that. The shape may be e.g. a polygonal shape such as a pentagonal shape, a circular shape, an oval shape, or the like. The shape of the force detection element 41 in the plan view is a square shape in the drawing, however, not limited to that. The shape may be e.g. a polygonal shape such as a pentagonal shape, a circular shape, an oval shape, or the like.

The force detection element 41 has a function of outputting charge Qx according to the component in the x-axis direction of the external force applied to the force detection element 41, charge Qy according to the component in the y-axis direction of the external force applied to the force detection element 41, and charge Qz according to the component in the z-axis direction of the external force applied to the force detection element 41. As shown in FIG. 3, the force detection element 41 has a piezoelectric element 5a that outputs the charge Qy according to the external force (shear force) parallel to the y-axis, a piezoelectric element 5b that outputs the charge Qz according to the external force (compressive/tensile force) parallel to the z-axis, and a piezoelectric element 5c that outputs the charge Qx according to the external force (shear force) parallel to the x-axis. Here, the piezoelectric element 5a, the piezoelectric element 5b, the piezoelectric element 5c are stacked in this order. Further, insulating adhesives 56 respectively intervene between the piezoelectric elements 5a, 5b and between the piezoelectric elements 5b, 5c and the elements are joined. Note that, hereinafter, the piezoelectric elements 5a, 5b, 5c are also respectively referred to as “piezoelectric element 5”.

Each of the piezoelectric elements 5a, 5b, 5c has two electrodes 51, a piezoelectric material 52, two electrodes 53, a piezoelectric material 54, and two electrodes 55 stacked in this order.

The piezoelectric materials 52, 54 respectively have plate shapes or sheet shapes and are formed by quartz crystals. Note that, as shown by arrows in FIG. 3, directions of X-axes (electrical axes) as crystal axes of the quartz crystals forming the piezoelectric materials 52, 54 are different from one another with respect to each of the piezoelectric elements 5a, 5b, 5c.

Here, the X-axis of the piezoelectric material 52a as the piezoelectric material 52 of the piezoelectric element 5a heads to the right side in FIG. 3. The X-axis of the piezoelectric material 54a as the piezoelectric material 54 of the piezoelectric element 5a heads to the left side in FIG. 3. The X-axis of the piezoelectric material 52b as the piezoelectric material 52 of the piezoelectric element 5b heads to the upside in FIG. 3. The X-axis of the piezoelectric material 54b as the piezoelectric material 54 of the piezoelectric element 5b heads to the downside in FIG. 3. The X-axis of the piezoelectric material 52c as the piezoelectric material 52 of the piezoelectric element 5c heads to the near side of the paper surface in FIG. 3. The X-axis of the piezoelectric material 54c as the piezoelectric material 54 of the piezoelectric element 5c heads to the far side of the paper surface in FIG. 3. The piezoelectric materials 52a, 54a, 52c, 54c are respectively formed by Y-cut quartz crystal plates and the directions of the X-axes are different by 90° in the order of 52a, 52c, 54a, 54c. Further, the piezoelectric materials 52b, 54b are respectively formed by X-cut quartz crystal plates and the directions of the X-axes are different by 180° from each other.

The two electrodes 51 are divisionally provided on the left and right in FIG. 3 side by side in the y-axis direction. Similarly, the two electrodes 53 and the two electrodes 55 are divisionally provided on the left and right in FIG. 3 side by side in the y-axis direction. The electrodes 51, 53, 55 on one side in the y-axis direction are provided to be superimposed on one another in the z-axis direction. Similarly, the electrodes 51, 53, 55 on the other side in the y-axis direction are provided to be superimposed on one another in the z-axis direction.

As shown in FIG. 4, “piezoelectric element 50a” having the electrodes 51, 53 on one side in the y-axis direction (on the left side in the drawing) and the piezoelectric material between the electrodes is formed. Similarly, “piezoelectric element 50b” having the electrodes 51, 53 on the other side in the y-axis direction (on the right side in the drawing) and the piezoelectric material 52 between the electrodes is formed. Further, “piezoelectric element 50c” having the electrodes 53, 55 on one side in the y-axis direction (on the left side in the drawing) and the piezoelectric material 54 between the electrodes is formed. Similarly, “piezoelectric element 50d” having the electrodes 53, 55 on the other side in the y-axis direction (on the right side in the drawing) and the piezoelectric material 54 between the electrodes is formed. Note that, hereinafter, the piezoelectric elements 50a, 50b, 50c, 50d are also respectively referred to as “piezoelectric element 50”.

As described above, the piezoelectric elements 50a, 50b are arranged side by side along the same plane. Therefore, the piezoelectric elements 50a, 50b are arranged without overlap with each other in the plan view. Similarly, the piezoelectric elements 50c, 50d are arranged without overlap with each other in the plan view.

The electrode 51 on one side in the y-axis direction (on the right side in the drawing) of the two electrodes 51 and the electrode 53 on the other side in the y-axis direction (on the left side in the drawing) of the two electrodes 53 are electrically connected via a wire 57. Thereby, the piezoelectric elements 50a, 50b are electrically series-connected. Similarly, the electrode 53 on one side in the y-axis direction (on the left side in the drawing) of the two electrodes 53 and the electrode 55 on the other side in the y-axis direction (on the right side in the drawing) of the two electrodes 55 are electrically connected via a wire 58. Thereby, the piezoelectric elements 50c, 50d are electrically series-connected.

As described above, the piezoelectric elements 50a, 50b arranged without overlap with each other in the plan view are electrically-series connected and the piezoelectric elements 50c, 50d arranged without overlap with each other in the plan view are electrically-series connected, and thereby, the S/N ratio may be improved without enlargement of the piezoelectric elements 5, reduction in load bearing, or reduction in responsiveness. Note that the point will be described later in detail.

The respective constituent materials of the electrodes 51, 53, 55 are not particularly limited as long as the materials may function as electrodes, but include e.g. nickel, gold, titanium, aluminum, copper, iron, chromium, or alloys containing the metals. One or two kinds of them may be combined (stacked, for example) and used.

As above, the force detection element 41 is explained, however, the numbers of piezoelectric elements and piezoelectric layers forming the force detection element 41 are not limited to the above described numbers. For example, the number of piezoelectric layers of each piezoelectric element 5 may be one, three, or more, and the number of piezoelectric elements 5 of the force detection element 41 may be two, four, or more.

### Pressurization Bolts (Fastening Members)

As shown in FIG. 2, the plurality of pressurization bolts 6 fasten the first base part 2 and the second base part 3 to each other while pressurizing the sensor devices 4 (more specifically, the piezoelectric elements 5) sandwiched by the first base part 2 and the second base part 3. Here, the head portion 61 is provided in the one end part of each pressurization bolt 6 and a male screw 62 is provided in the other end part, and the respective pressurization bolts 6 are inserted into the through holes 32 of the above described second base part 3 from the opposite side to the first base part 2. The head portions 61 engage with the step portions of the through holes 32 and the male screws 62 are screwed together with the female screws 22 of the above described first base part 2. By the plurality of pressurization bolts 6, the force detection element 41 may be sandwiched and pressurized by the top surfaces 211 of the convex portions 21 of the first base part 2 and the lower surface 31 of the second base part 3 via the packages 42 of the sensor devices 4. The fastening forces of the respective pressurization bolts 6 are appropriately adjusted, and thereby, pressure having a predetermined magnitude in the z-axis direction may be applied to the force detection element 41 as pressurization. The constituent material of the respective pressurization bolts 6 is not particularly limited to, but includes e.g. various metal materials etc.

Note that the positions and the number of the respective pressurization bolts 6 are respectively not limited to the illustrated positions and number. For example, regarding at least two of the plurality of pressurization bolts 6, distances from the axis line z1 may be different from each other. The number of pressurization bolts 6 may be e.g. three or less or five or more.

### Analog Circuit Board

The analog circuit board 7 is provided between the above described first base part 2 and second base part 3. Thereby, the wiring length from the sensor device 4 may be reduced and there is an advantage that the reduction contributes to simplification of the structure. In the analog circuit board 7, through holes 71 through which the respective convex portions 21 of the first base part 2 are inserted and through holes 72 through which the respective pressurization bolts 6 are inserted are formed. The analog circuit board 7 is fixed and supported with respect to the sensor devices 4 via the terminals 43.

The analog circuit board 7 is electrically connected to the plurality of terminals 43 of the above described sensor devices 4. As shown in FIG. 5, the analog circuit board 7 includes a charge amplifier 9 (conversion output circuit) that respectively converts charge Q (Qx, Qy, Qz) output from the force detection elements 41 of the sensor devices 4 into voltages V (Vx, Vy, Vz).

The charge amplifier 9 has an operational amplifier 91 and a capacitor 92 (integrating capacitor). The operational amplifier 91 has an inverting input terminal, a non-inverting input terminal, and an output terminal, amplifies the potential difference between the inverting input terminal and the non-inverting input terminal, and outputs the amplified voltage from the output terminal. The inverting input terminal of the operational amplifier 91 is electrically connected to the piezoelectric element 5 including the plurality of series-connected piezoelectric elements 50. On the other hand, the non-inverting input terminal of the operational amplifier 91 is electrically connected to the ground potential. Further, the capacitor 92 is electrically parallel-connected between the inverting input terminal and the output terminal of the operational amplifier 91.

In the charge amplifier 9, the charge (charge signals) output from the piezoelectric element 5 is charged in the capacitor 92 and voltages (voltage signals) obtained by the voltage of the capacitor 92 (i.e., quotient values of the charge by the capacitor 92) are output from the output terminal of the operational amplifier 91. Further, a switching element (not shown) is parallel-connected between the inverting input terminal and the output terminal of the operational amplifier 91 like the capacitor 92. By the switching element, the charge charged in the capacitor 92 may be reset to zero (0).

### Digital Circuit Board

The digital circuit board 8 is provided between the above described first base part 2 and second base part 3 (more specifically, between the first base part 2 and the analog circuit board 7). Thereby, the wiring length from the analog circuit board 7 may be reduced and there is an advantage that the reduction contributes to simplification of the structure. Like the above described analog circuit board 7, in the digital circuit board 8, through holes 81 through which the respective convex portions 21 of the first base part 2 are inserted and through holes 82 through which the respective pressurization bolts 6 are inserted are formed. The digital circuit board 8 is fixed and supported with respect to the convex portions 21 by fitting or an adhesive or the like.

The digital circuit board 8 is electrically connected to the above described analog circuit board 7. The digital circuit board 8 includes an external force detection circuit (not shown) that detects (calculates) an external force based on the voltages Vx, Vy, Vz from the analog circuit board 7. The external force detection circuit may include e.g. an AD converter and an operational circuit such as a CPU connected to the AD converter.

Here, the digital circuit board 8 calculates the translational force component Fx in the x-axis direction, the translational force component Fy in the y-axis direction, the translational force component Fz in the z-axis direction, the rotational force component Mx in the x-axis direction, the rotational force component My in the y-axis direction, and the rotational force component Mz in the z-axis direction based on voltages Vxa, Vya, Vza, Vxb, Vyb, Vzb, Vxc, Vyc, Vzc, Vxd, Vyd, Vzd. The respective force components may be obtained by the following expressions.

Fx=R1×(Vxa+Vxb+Vxc+Vxd)/4

Fy=R1×(Vya+Vyb+Vyc+Vyd)/4

Fz=R2×(Vza+Vzb+Vzc+Vzd)/4

Mx=R2×(Vzd−Vzb)/2

My=R2×(Vzc−Vza)/2

Mz=R1×(Vxb−Vxd+Vya−Vyc)/4

Here, R1 and R2 are respectively unit conversion constants for conversion of the voltages into forces. Further, “voltages Vxa, Vya, Vza”, “voltages Vxb, Vyb, Vzb”, “Vxc, Vyc, Vzc”, and “Vxd, Vyd, Vzd” are the voltages Vx, Vy, Vz corresponding to the four sensor devices 4 (the sensor devices 4a, 4b, 4c, 4d shown in FIG. 1).

As described above, the force sensor 1 may detect the translational force components Fx, Fy, Fz and the rotational force components Mx, My, Mz. Note that the digital circuit board 8 may perform e.g. correction for eliminating differences in sensitivity among the respective conversion output circuits or the like in addition to the above described calculation.

As described above, the force sensor 1 having the above explained configuration includes the base portion 421 having the placement surface 423 and the plurality of piezoelectric elements 50 (more specifically, the piezoelectric elements 50a, 50b or piezoelectric elements 50c, 50d) arranged side by side in the direction along the placement surface 423, electrically series-connected, and outputting charge when subjected to an external force. Here, the respective piezoelectric elements 50a, 50b have the two electrodes 51, 53 and the piezoelectric materials 52 provided between the two electrodes 51, 53, and are arranged without overlap with each other in the plan view as seen from the direction in which the two electrodes 51, 53 are arranged (z-axis direction) (hereinafter, also simply referred to as “plan view”). Similarly, the respective piezoelectric elements 50c, 50d have the two electrodes 53, 55 and the piezoelectric materials 54 provided between the two electrodes 53, 55, and are arranged without overlap with each other in the plan view as seen from the direction in which the two electrodes 53, 55 are arranged. Note that the direction in which the two electrodes 51, 53 or two electrodes 53, 55 are arranged may be considered as a direction in which the piezoelectric elements 50 are subjected to an external force to be detected, as the thickness direction of the respective piezoelectric elements 50, or the normal direction of the placement surface 423.

According to the force sensor 1, the plurality of piezoelectric elements 50 arranged side by side along the placement surface 423 (in other words, the plurality of piezoelectric elements 50 arranged without overlap with each other in the plan view) are electrically series-connected, and thereby, compared to the case using one piezoelectric element having the same placement area (same plan view area), noise may be reduced and, as a result, the S/N ratio may be improved. The S/N ratio is improved for the following reasons. Note that, as below, the piezoelectric elements 50a, 50b will be explained, however, the same applies to the piezoelectric elements 50c, 50d.

When the piezoelectric elements 50a, 50b are regarded as pieces obtained by division of a piezoelectric element having an equal plan view area to the total of the plan view areas of the elements (hereinafter, referred to as “undivided piezoelectric element”) by n (two in the embodiment), the magnitude of the force applied to the respective piezoelectric elements 50a, 50b per unit area is the same as the magnitude of the force applied to the undivided piezoelectric element per unit area. Here, the amount of charge output from the piezoelectric element when subjected to a force is proportional to the plan view area of the piezoelectric element, and thus, letting the amount of charge output from the undivided piezoelectric element be Q, the amount of charge output from the series-connected piezoelectric elements 50a, 50b is Q/n.

Further, the element noise (thermal noise currents) of the piezoelectric elements 50a, 50b is inversely proportional to the roots of the leakage resistances of the piezoelectric elements 50a, 50b. The respective leakage resistances of the piezoelectric elements 50a, 50b are n times the leakage resistance of the undivided piezoelectric element, and the combined leakage resistance of the series-connected piezoelectric elements 50a, 50b is n² times the leakage resistance of the undivided piezoelectric element. Therefore, the combined element noise of the series-connected piezoelectric elements 50a, 50b is a fraction of √(n²) of the element noise of the undivided piezoelectric element, and, letting the element noise of the undivided piezoelectric element be I_{ND}, is I_{ND}/n.

On the other hand, as described above, the force sensor 1 includes the charge amplifier 9 to which the charge from the series-connected piezoelectric elements 50a, 50b is input. The circuit noise of the charge amplifier 9 (the noise of the first transistor of the operational amplifier 91) is amplified in proportion to the capacity connected to the input side of the operational amplifier 91. Regarding the capacity, when the element capacity of the piezoelectric element is designed to be dominant, the element capacity of each of the piezoelectric elements 50a, 50b is one nth of the element capacity of the undivided piezoelectric element and the combined element capacity of the series-connected piezoelectric elements 50a, 50b is one n²th of the leakage resistance of the undivided piezoelectric element, and thus, letting the circuit noise when the undivided piezoelectric element is used be V_{NC}, the circuit noise when the series-connected piezoelectric elements 50a, 50b are used is V_{NC}/n².

The element noise of the piezoelectric elements 50a, 50b is cut off at the time constant of the extremely low frequency by low-pass filters of the piezoelectric elements 50a, 50b themselves, only the extremely low frequency components are transmitted to the operational amplifier 91, and thereby, the circuit noise is dominant as noise.

Therefore, a relation of S/N∝Q/n/(V_{NC}/n²)=(Q/V_{NC})×n is satisfied. That is, the S/N ratio is larger in proportional to the division number n.

In the above described manner, the S/N ratio may be improved. Note that, in the case without the series connection, S/N∝Q/V_{NC} is satisfied and it is known that the S/N ratio is larger in the series connection.

As described above, the force sensor 1 includes the charge amplifier 9 to which charge is input. Thereby, the charge (charge signals) output from the plurality of piezoelectric elements 50 may be converted into voltages (voltage signals). Then, external forces applied to the plurality of piezoelectric elements 50 may be easily and accurately calculated based on the voltage signals from the charge amplifier 9. Even very small charge may be amplified near the piezoelectric elements 50 and, as a result, the sensor has an advantage in resistance to disturbance. Further, the charge from the piezoelectric elements 50 is transferred and held in the capacitor 92 (tank capacity) and no voltage is applied between the electrodes of the piezoelectric elements 50, and thus, the charge is not discharged from the electrodes of the piezoelectric elements 50 due to the element leakage, and the sensor has another advantage in prolonged operation.

In the embodiment, the piezoelectric materials 52 or piezoelectric materials 54 of the plurality of piezoelectric elements 50 are not divided with respect to each piezoelectric element 50, but integrated. That is, the piezoelectric materials 52 or piezoelectric materials 54 are provided in common with the plurality of piezoelectric elements 50. Thereby, processing of the piezoelectric materials 52, 54 is easier and, as a result, manufacture of the plurality of piezoelectric elements 50 is easier.

As described above, the piezoelectric materials 52, 54 are formed by quartz crystal. Thereby, the force sensor 1 having excellent properties including higher sensitivity, wider dynamic range, higher rigidity may be realized.

Further, as described above, the plurality of piezoelectric elements 50 are stacked in the direction in which the two electrodes 51, 53 or two electrodes 53, 55 are arranged. The force sensor 1 includes the plurality of piezoelectric elements 50, and thereby, the sensitivity and the detection axes of the force sensor 1 may be increased.

### Second Embodiment

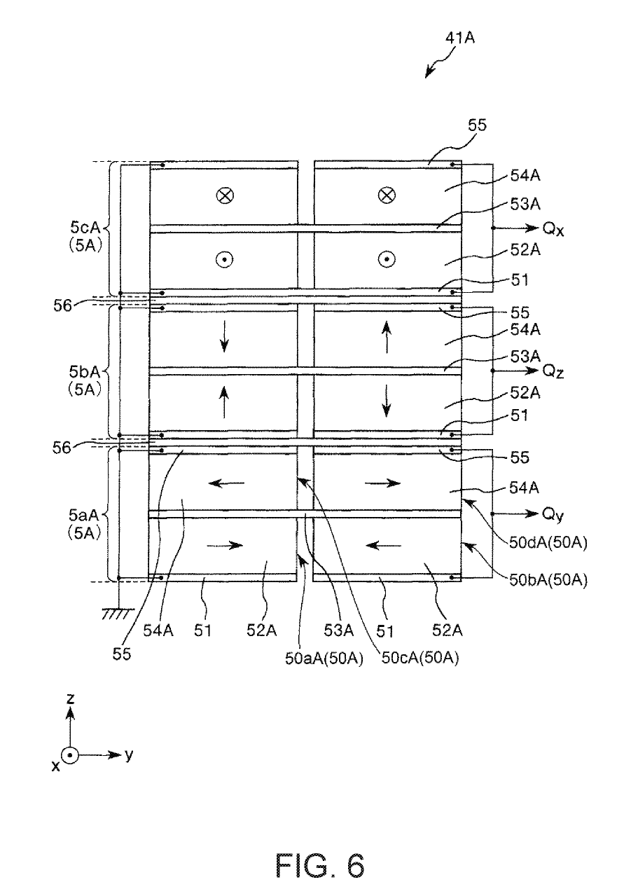

FIG. 6 is a sectional view of a force detection element (piezoelectric elements) of a force sensor according to the second embodiment of the invention.

As below, the second embodiment will be explained with a focus on the differences from the above described embodiment and the explanation of the same items will be omitted. Note that, in FIG. 6, the same configurations as those of the above described embodiment have the same signs.

A force detection element 41A shown in FIG. 6 has a plurality of stacked piezoelectric elements 5A (5aA, 5bA, 5cA). Each piezoelectric element 5A has two electrodes 51, two piezoelectric materials 52A, one electrode 53A, two piezoelectric materials 54A, and two electrodes 55 stacked in this order. Each piezoelectric element 5A has two piezoelectric elements 50aA (50A), 50bA (50A) with the electrodes 51, 53A and the piezoelectric materials 52A provided between the electrodes, and two piezoelectric elements 50cA (50A), 50dA (50A) with the electrodes 53A, 55 and the piezoelectric materials 54A provided between the electrodes.

Here, the piezoelectric material 52A of the piezoelectric element 50aA and the piezoelectric material 52A of the piezoelectric element 50bA are separated from each other and the directions of the X-axes of the quartz crystal are different by 180° from each other. Similarly, the piezoelectric material 54A of the piezoelectric element 50cA and the piezoelectric material 54A of the piezoelectric element 50dA are separated from each other and the directions of the X-axes of the quartz crystals are different by 180° from each other.

Further, the piezoelectric elements 50aA, 50bA are electrically series-connected. Similarly, the piezoelectric elements 50cA, 50dA are electrically series-connected.

In the force detection element 41A, the plurality of piezoelectric elements 50A arranged without overlap with each other in the plan view (the piezoelectric elements 50aA, 50bA or piezoelectric elements 50cA, 50dA) are electrically series-connected, and thereby, compared to the case using one piezoelectric element having the same placement area (same plan view area), noise may be reduced and, as a result, the S/N ratio may be improved.

### Third Embodiment

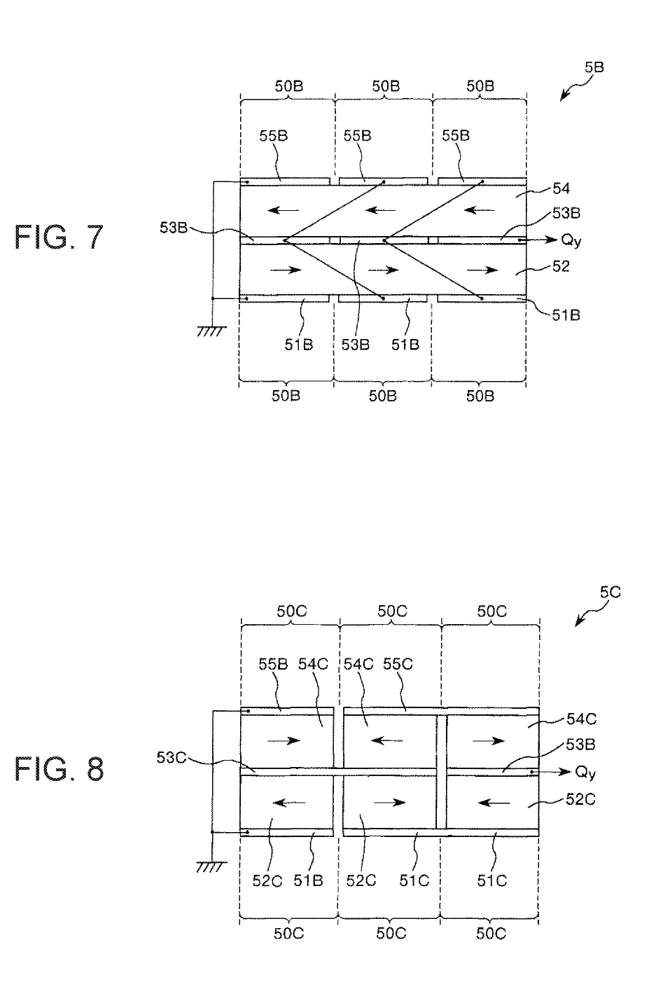

FIG. 7 is a sectional view of a piezoelectric element of a force sensor according to the third embodiment of the invention.

As below, the third embodiment will be explained with a focus on the differences from the above described embodiments and the explanation of the same items will be omitted. Note that, in FIG. 7, the same configurations as those of the above described embodiments have the same signs.

A piezoelectric element 5B shown in FIG. 7 has three electrodes 51B, one piezoelectric material 52, three electrodes 53B, one piezoelectric material 54, and three electrodes 55B stacked in this order. Further, the piezoelectric element 5B has three piezoelectric elements 50B with the electrodes 51B, 53B and the piezoelectric material 52 provided between the electrodes and they are electrically series-connected. Similarly, the piezoelectric element 5B has three piezoelectric elements 50B with the electrodes 53B, 55B and the piezoelectric material 54 provided between the electrodes and they are electrically series-connected.

The three piezoelectric elements 50B containing the piezoelectric material 52 or piezoelectric material 54 are arranged without overlap with each other in the plan view and electrically series-connected, and thereby, compared to the case using one piezoelectric element having the same placement area (same plan view area), noise may be reduced and, as a result, the S/N ratio may be improved. Note that the piezoelectric elements 5B having the piezoelectric elements 50B stacked like the piezoelectric elements 5 of the above described embodiments may form a force detection element that can detect forces along three axes.

### Fourth Embodiment

FIG. 8 is a sectional view of a piezoelectric element of a force sensor according to the fourth embodiment of the invention.

As below, the fourth embodiment will be explained with a focus on the differences from the above described embodiments and the explanation of the same items will be omitted. Note that, in FIG. 8, the same configurations as those of the above described embodiments have the same signs.

A piezoelectric element 5C shown in FIG. 8 has two electrodes 51B, 51C, three piezoelectric materials 52C, two electrodes 53B, 53C, three piezoelectric materials 54C, and two electrodes 55B, 55C stacked in this order. Further, the piezoelectric element 5C has a piezoelectric element 50C with the electrodes 51B, 53C and the piezoelectric material 52C provided between the electrodes, a piezoelectric element 50C with the electrodes 51C, 53C and the piezoelectric material 52C provided between the electrodes, and a piezoelectric element 50C with the electrodes 51C, 53B and the piezoelectric material 52C provided between the electrodes and they are electrically series-connected. Similarly, the piezoelectric element 5C has a piezoelectric element 50C with the electrodes 53C, 55B and the piezoelectric material 54C provided between the electrodes, a piezoelectric element 50C with the electrodes 53C, 55C and the piezoelectric material 54C provided between the electrodes, and a piezoelectric element 50C with the electrodes 53B, 55C and the piezoelectric material 54C provided between the electrodes and they are electrically series-connected.

The three piezoelectric elements 50C containing the piezoelectric materials 52C or piezoelectric materials 54C are arranged without overlap with each other in the plan view and electrically series-connected, and thereby, compared to the case using one piezoelectric element having the same placement area (same plan view area), noise may be reduced and, as a result, the S/N ratio may be improved. Note that the piezoelectric elements 5C having the piezoelectric elements 50C stacked like the piezoelectric elements 5 of the above described embodiments may form a force detection element that can detect forces along three axes.

### Robot

As below, a robot according to the invention will be explained with a single-arm robot as an example.

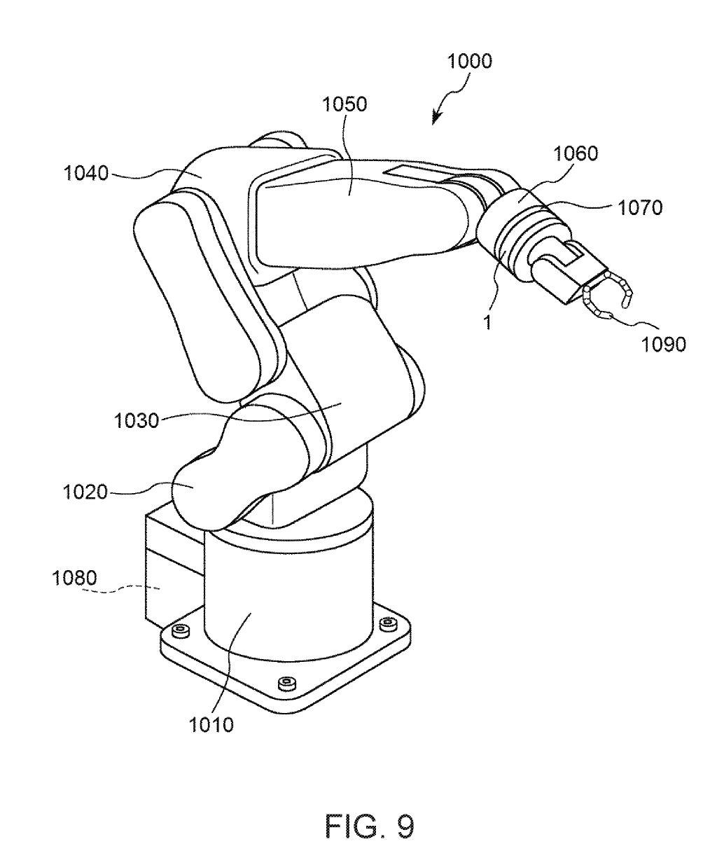

FIG. 9 is a perspective view showing an example of the robot according to the invention.

A robot 1000 shown in FIG. 9 may perform work of feeding, removing, carrying, assembly, etc. of precision apparatuses and components forming the apparatuses (objects). The robot 1000 is a six-axis robot, and has a base 1010 fixed to a floor or ceiling, an arm 1020 rotatably coupled to the base 1010, an arm 1030 rotatably coupled to the arm 1020, an arm 1040 rotatably coupled to the arm 1030, an arm 1050 rotatably coupled to the arm 1040, an arm 1060 rotatably coupled to the arm 1050, an arm 1070 rotatably coupled to the arm 1060, and a control unit 1080 that controls driving of these arms 1020, 1030, 1040, 1050, 1060, 1070. Further, a hand connecting part is provided in the arm 1070, and an end effector 1090 according to work to be executed by the robot 1000 is attached to the hand connecting part.

In the robot 1000, the force sensor 1 that detects an external force applied to the end effector 1090 is provided near the end effector 1090. The force detected by the force sensor 1 is fed back to the control unit 1080, and thereby, the robot 1000 may execute more precise work. Further, the robot 1000 may sense contact of the end effector 1090 with an obstacle or the like by the force detected by the force sensor 1. Accordingly, obstacle avoidance operation, object damage avoidance operation, etc. that have been difficult in the position control of related art may be easily performed, and the robot 1000 may execute work more safely. Note that, in addition, for example, the force sensors 1 as torque sensors may be provided in joint parts of the respective arms 1020, 1030, 1040, 1050, 1060, 1070.

The robot 1000 has the force sensor 1 as described above. Thereby, the S/N ratio of the force sensor 1 may be improved and, high-accuracy operation control of the robot 1000 can be performed using the detection result of the force sensor 1, for example.

Note that the number of arms of the robot 1000 is five in the drawing, however, not limited to that. The number may be one to four, six, or more.

As above, the force sensor and the robot according to the invention are explained based on the illustrated embodiments, however, the invention is not limited to those. The configurations of the respective parts may be replaced by arbitrary configurations having the same functions. Further, other arbitrary configurations may be added to the invention.

Or, arbitrary two or more configurations (features) of the above described embodiments may be combined.

Or, the package of the sensor device may be omitted.

The fastening members that provide pressurization to the piezoelectric elements are not limited to the forms like the above described pressurization bolts as long as the members may fasten the first base part and the second base part to each other pressurized with the piezoelectric elements sandwiched by the first base part and the second base part. The pressurization bolts may be provided as appropriate or omitted, or fasten the first base part and the second base part to each other without pressurization on the piezoelectric elements.

The robot according to the invention is not limited to the single-arm robot as long as the robot has an arm, but may be e.g. another robot such as a dual-arm robot or scalar robot.

The force sensor according to the invention may be incorporated into another apparatus than the robot, and may be mounted on e.g. a vehicle such as an automobile.

In the above described embodiments, the case where quartz crystal is used for the piezoelectric material of the piezoelectric element is explained as an example, however, the piezoelectric material is not limited to that as long as the material has a piezoelectric property. For example, lead titanate (PbTiO₃), lead zirconate titanate (Pb(Zr,Ti) O₃), lead zirconate (PbZrO₃), lead lanthanum titanate ((Pb,La), TiO₃), lead lanthanum zirconate titanate ((Pb,La),(Zr,Ti)O₃), lead niobate zirconate titanate (Pb(Zr,Ti,Nb)O₃), lead magnesium niobate zirconium titanate (Pb(Zr,Ti) (Mg,Nb)O₃), or the like may be used.

The entire disclosure of Japanese Patent Application No. 2016-231824, filed Nov. 29, 2016 is expressly incorporated by reference herein.

What is claimed is:

1. A force sensor comprising a plurality of piezoelectric elements that output charge when subjected to an external force,
each of the plurality of piezoelectric elements having two electrodes and a piezoelectric material provided between the two electrodes,
the piezoelectric elements arranged without overlap with each other in a plan view as seen from a direction in which the two electrodes are arranged,
the piezoelectric elements are electrically series-connected.

2. The force sensor according to claim 1, wherein the piezoelectric materials of the plurality of piezoelectric elements are integrally formed.

3. The force sensor according to claim 1, wherein the plurality of piezoelectric elements are stacked in the direction in which the two electrodes are arranged.

4. The force sensor according to claim 1, wherein the piezoelectric material is formed by quartz crystal.

5. The force sensor according to claim 1, further comprising a charge amplifier to which the change is input.

6. A force sensor comprising:
a base portion having a placement surface; and
a plurality of piezoelectric elements arranged side by side in a direction along the placement surface, electrically series-connected, and outputting charge when subjected to an external force.

7. A robot comprising the force sensor according to claim 1.

8. A robot comprising the force sensor according to claim 2.

9. A robot comprising the force sensor according to claim 3.

10. A robot comprising the force sensor according to claim 4.

11. A robot comprising the force sensor according to claim 5.

12. A robot comprising the force sensor according to claim 6.
